(19) United States
(12) Patent Application Publication
(10) Pub. No.: US 2025/0373313 A1
(43) Pub. Date: Dec. 4, 2025

(54) METHOD AND APPARATUS FOR IMPROVING COMMUNICATION PERFORMANCE OF VEHICLE SYSTEM

(71) Applicants: HYUNDAI MOTOR COMPANY, Seoul (KR); KIA CORPORATION, Seoul (KR)

(72) Inventors: Oh Yun KWON, Hwaseong-si (KR); Kwang Woo RYU, Hwaseong-si (KR)

(21) Appl. No.: 18/971,852

(22) Filed: Dec. 6, 2024

(30) Foreign Application Priority Data
Jun. 3, 2024 (KR) 10-2024-0072469

(51) Int. Cl. H04B 7/06; H04B 1/401; H04B 7/08

(52) U.S. Cl. CPC H04B 7/06958; H04B 1/401; H04B 7/088

(57) ABSTRACT

A vehicle communication method can include: switching the vehicle's mode to ACC mode; performing first beamforming with respect to a beam directed at an angle θ(0°≤θ≤180°); calculating first received power for the first beamformed beam; switching the vehicle's mode to IGN on or Start mode; performing second beamforming with respect to the beam directed at the angle θ; calculating second received power for the second beamformed beam; comparing the absolute value of a difference between the first received power and the second received power with a preset value K; and determining whether or not to transmit and receive the beam directed at the angle θ based on a result of the comparison.

### CROSS-REFERENCE TO RELATED APPLICATION

This application claims priority to Patent Application No. 10-2024-0072469, filed on Jun. 3, 2024 in Korea, the entire contents of which are incorporated herein by reference.

### TECHNICAL FIELD

The present disclosure relates to a method and an apparatus for improving the communication performance of a vehicle system.

### BACKGROUND

Vehicles are often equipped with additional features such as audio, video, navigation, air conditioning, and communication systems, in addition to basic driving functions, to enhance passenger convenience.

An infotainment system integrates information and entertainment, where the information pertains to driving, navigation, and other necessary data, while the entertainment covers a range of multimedia and user friendly features. Infotainment-related technologies are advancing rapidly as in-car navigation systems, audio and video systems, smartphones, and tablet PCs have become commonplace, alongside the evolution of information technology (IT).

Existing infotainment technologies have primarily focused on delivering services to front-seat passengers, with new developments now addressing the needs of backseat passengers.

Meanwhile, various types of communication noise can affect vehicles. This noise can be categorized as either external noise, caused by environmental factors outside the vehicle, or internal noise, originating from components inside the vehicle. The internal noise includes multipath fading, which results from the combination of electrical noise generated by electrical and electronic components (hereinafter, “electrical components”) and electromagnetic waves that are reflected multiple times by surrounding objects.

A backseat infotainment system often utilizes wireless communication techniques such as Wi-Fi. On e such technique is beamforming, which involves shaping a signal's radiation pattern to enhance communication performance. Beamforming increases transmission and reception gain, strengthening the received signal for a specific receiver by directing beams using one or more antennas. There is growing demand for techniques that employ beamforming to reduce noise within a vehicle and improve communication performance, ensuring uninterrupted service for backseat passengers.

### SUMMARY

The present disclosure is directed to a vehicle communication apparatus that employs a beamforming technique to improve the communication performance of a backseat infotainment system and provide high-quality service to passengers.

According to one aspect of the present disclosure, a vehicle communication method can include: switching the vehicle's mode to ACC mode; performing first beamforming with respect to a beam directed at an angle θ(0°≤θ≤180°); calculating first received power for the first beamformed beam; switching the vehicle's mode to IGN on or Start mode; performing second beamforming with respect to the beam directed at the angle θ; calculating second received power for the second beamformed beam; comparing the absolute value of a difference between the first received power and the second received power with a preset value K; and determining whether or not to transmit and receive the beam directed at the angle θ based on a result of the comparison.

According to another aspect of the present disclosure, a vehicle communication apparatus can include: at least one memory storing instructions; and at least one processor, wherein, by executing the instructions, the at least one processor senses a target around the vehicle, switches the vehicle's mode to ACC mode, performs first beamforming with respect to a beam directed at an angle θ(0°≤θ≤180°), calculates first received power for the first beamformed beam, switches the vehicle's mode to IGN on or Start mode, performs second beamforming with respect to the beam directed at the angle θ, calculates second received power for the second beamformed beam, compares the absolute value of a difference between the first received power and the second received power with a preset value K, and determines whether or not to transmit and receive the beam directed at the angle θ based on a result of the comparison.

According to implementations of these features, a vehicle communication apparatus can employ a beamforming technique to improve the communication performance of a backseat infotainment system and provide high-quality service to passengers.

### BRIEF DESCRIPTION OF THE DRAWINGS

FIG. 1 is a diagram illustrating an example of a vehicle communication apparatus.

FIG. 2 is a flowchart for explaining an example of an operation of a vehicle communication apparatus.

FIG. 3 is a diagram illustrating an example of a method for determining a beam direction by a vehicle communication apparatus.

FIG. 4 is a diagram illustrating an example of a method for correcting a beam direction by a vehicle communication apparatus.

FIG. 5 is a diagram illustrating an example of a vehicle communication apparatus installed inside a vehicle,

FIG. 6 is a diagram illustrating an example of a process of calculating a difference in received power by a vehicle communication apparatus.

FIG. 7 a flowchart for explaining an example of a communication method.

FIG. 8 is a diagram illustrating an exemplary computing device that can be used to implement a method and a vehicle communication apparatus.

### DETAILED DESCRIPTION

Hereinafter, “electrical component” may refer to all parts or devices through which electricity flows, including a motor, a black box, a central control unit, a speed sensor, a switch, a speaker, an audio system, and a camera.

Hereinafter, “ACC mode” may refer to a state in which only electrical components not related to driving are powered on, including radio, a navigation system, a clock, and a blower. “IGN on mode and Start mode” may refer to a state in which all electrical components are powered on.

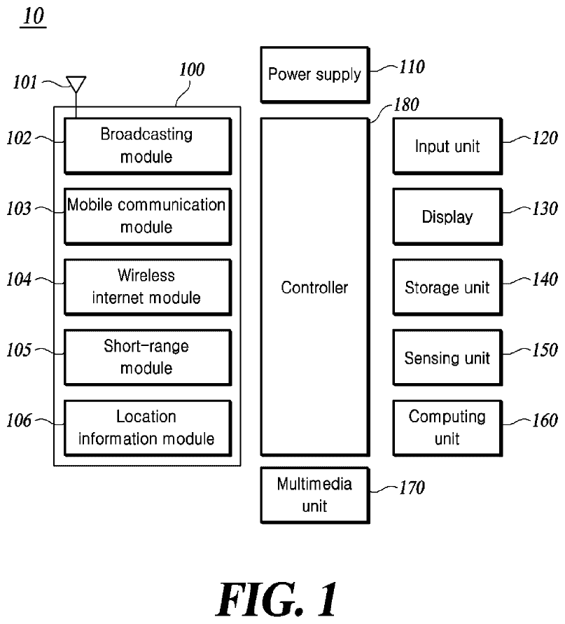

FIG. 1 is a diagram illustrating an example of a vehicle communication apparatus,

A vehicle communication apparatus 10 can include at least one of a communication unit 100, a power supply 110, an input unit 120, a display 130, a storage unit 140, a sensing unit 150, a computing unit 160, a multimedia unit 170, or a controller 180.

The communication unit 100 can include one or more modules that enable wireless communication between the vehicle communication apparatus 10 and a wireless communication system or between the vehicle communication apparatus 10 and a network where the vehicle communication apparatus 10 is located. The communication unit 100 can include a WI-FI antenna 101, a broadcasting module 102, a mobile communication module 103, a wireless internet module 104, a short-range communication module 105, and a location information module 106.

One or more antennas 1 can be provided. A plurality of WI-FI antennas can be disposed in a linear array, a planar array, and/or a circular array. In some implementations, the plurality of Wi-Fi antennas can be disposed in various arrays as long as the position and direction of a signal can be quickly and accurately detected.

The broadcasting module 102 can receive broadcast signals and/or broadcast-related information from an external broadcast management server via a broadcast channel, The broadcast channel can include a satellite channel and a terrestrial channel. The broadcast-related information can refer to information related to a broadcast channel, a broadcast program, or a broadcast service provider. The broadcast-related information can be received by the mobile communication module 103.

The broadcasting module 102 can receive a digital broadcast signal by using a digital broadcast system such as DMB-T (Digital Multimedia Broadcasting-Terrestrial), DMB-S (Digital Multimedia Broadcasting-Satellite), MediaFLO (Media Forward Link Only), DVB-H (Digital Video Broadcast-Handheld), DVB-CBMS (Convergence of Broadcasting and VEHICLE Service), OMA-BCAST (Open VEHICLE Alliance-BroadCAST), CMMB (China Multimedia VEHICLE Broadcasting), MBBMS (VEHICLE Broadcasting Business Management System), and ISDB-T (Integrated Services Digital Broadcast-Terrestrial).

The mobile communication module 103 can transmit and receive a radio signal to and from at least one of a base station or a server over a mobile communication network such as GSM (Global System for VEHICLE communications), CDMA (Code Division Multiple Access), and WCDMA (Wideband CDMA), For example, the radio signal can include an audio signal, a video call signal, or various forms of data for text/multimedia message transmission and reception.

The wireless internet module 104 can refer to a module configured to support wireless internet access, and can be built in or externally installed to the vehicle communication apparatus 10. The wireless internet module 104 can utilize wireless internet access technologies including a WLAN (Wireless LAN), Wi-Fi, WIBRO (Wireless Broadband), WIMAX (World Interoperability for Microwave Access), HSDPA (High Speed Downlink Packet Access), GSM, CDMA, WCDMA, LTE (Long Term Evolution), and the like.

The short-range communication module 105 can refer to a module configured to support short-range communication. The short-range communication module 105 can utilize short-range communication technologies including Bluetooth, Radio Frequency Identification (RFID), Infrared Data Association (IrDA), Ultra WideBand (UWB), ZigBee, and the like.

The location information module 106 can acquire the location of the vehicle communication apparatus 10, and a representative example thereof is a GPS (Global Positioning System) module. The GPS module can calculate distance information and accurate time information from three or more satellites and trigonometry can then be applied to the calculated information to accurately calculate three-dimensional current location information in terms of latitude, longitude, and altitude information. In some implementations, a method of calculating location and time information by using three satellites and correcting an error of the calculated location and time information by using another single satellite can be utilized. In addition, the GPS module can calculate speed information by continuously calculating the current location in real time.

The power supply 110 can receive external power and internal power, by control from the controller 180, and supply power for operating individual components.

The input unit 120 can generate input data to control an operation of the vehicle communication apparatus 10. The input unit 120 can include a button positioned on the front side of the vehicle communication apparatus 10, a touch sensor (pressure/capacitive), a keypad, a dome switch, a jog wheel, a jog switch, and the like.

The display 130 can display information processed by the vehicle communication apparatus 10. For example, if the vehicle communication apparatus is in call mode, the display 130 can display a user interface (UI) or graphic user interface (GUI) related to the call.

The display 130 can include at least one of a liquid crystal display (LCD), a thin film transistor-liquid crystal display (TFT LCD), an organic light-emitting diode (OLED), a flexible display, or a three-dimensional display.

Two or more displays 130 can be provided. The vehicle communication apparatus 10 can be configured such that a plurality of displays are placed on one side at intervals or integrally or are arranged on different sides, respectively. The displays can be placed at front seats and/or backseats of the vehicle.

The storage unit 140 can store a program for running the vehicle communication apparatus 10 or can perform a function for temporarily storing input/output data.

The sensing unit 150 can determine the direction of a communication target by using a DoA (Direction of Arrival) technique and transmit information on the direction to the controller 180 and the communication unit 100.

The computing unit 160 can compute the received power Pr of a signal with respect to a particular angle by using a Friis formula. The Friis formula is given by Equation 1:

$${P}_{r} = {P}_{t} \frac{{G}_{t} {G}_{r} {λ}^{2}}{{( 4 π d )}^{2}} \qquad [ Equation 1 ]$$

Pᵣ can refer to the power of a received signal, Pt can refer to the power of a transmitted signal, Gₜ can refer to the antenna gain of a transmitter, Gᵣ can refer to the antenna gain of a receiver, λ can refer to the wavelength, and d can refer to the distance between the transmitter and the receiver. Equation 1 can be applied in free space. Accordingly, the equation can be modified according to the characteristics of the communication system when actually applied to the vehicle communication apparatus.

The computing unit 160 can compute the absolute value X of a difference between first received power Prₐ for ACC mode and second received power Prₛ for IGN on or Start mode (X=|Prₐ−Prₛ|). The computing unit 160 can compare X with an arbitrary value K. K can be changed by a passenger. If X is deemed to be greater than or equal to K, it can be determined that there is internal noise (X≥K). If X is deemed to be less than K, it can be determined that there is no internal noise (X<K). For example, the internal noise can include electrical component noise and multipath fading.

When the beam direction of a target communicating with the vehicle communication apparatus changes with a tilt, rotation, and movement of the vehicle communication apparatus caused by a motion of the vehicle communication apparatus, the computing unit 160 can measure and correct the amount of change in beam direction.

The multimedia unit 170 can allow passengers to watch movies, play games, check their SNS feeds, and watch TV by using a vehicle display.

The controller 180 can control an overall operation of the vehicle communication apparatus 10. The controller 180 can provide infotainment services to passengers by controlling the communication unit 100. Specifically, the controller 180 may control the communication unit 100 to operate in normal mode or beamforming mode. For example, the normal mode can be associated with controlling the communication unit 100 to function as a multiple-input and multiple-output (MIMO) antenna, and the beamforming mode can be associated with controlling the communication unit 100 to focus beams on a specified direction. The controller 180 can provide WI-FI service to passengers via seamless communication by controlling beamforming to be steered in a direction in which communication sensitivity is high. For example, the controller 180 can steer the beamforming in a direction in which communication sensitivity is greater than a predetermined threshold.

The controller 180 can control the communication unit 100 to avoid transmitting beams in a specified direction. The controller 180 can control the communication unit 100 to avoid transmitting or receiving beams in a direction identified by the computing unit 160 as the source of internal noise.

The controller 180 can control the vehicle's electrical components to be powered on or off. The controller 180 can request a passenger to switch the vehicle's mode to ACC mode or IGN on or Start mode. The controller 180 can switch the vehicle's mode to ACC mode or IGN on or Start mode.

It should be noted that not all of the blocks shown in FIG. 1 are essential components, and that, in other implementations, some blocks included in the vehicle communication apparatus 10 may be added, altered, or removed. For example, the components shown in FIG. 1 show functionally distinct elements, and at least one component can be implemented in such a manner as to be integrated together in an actual physical environment.

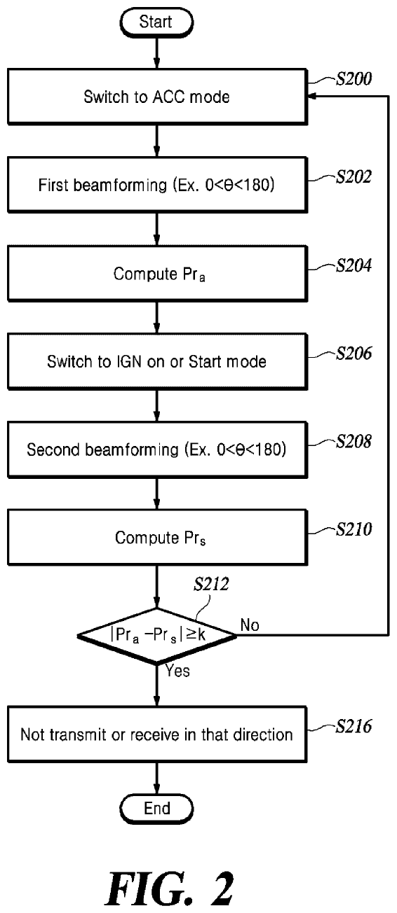

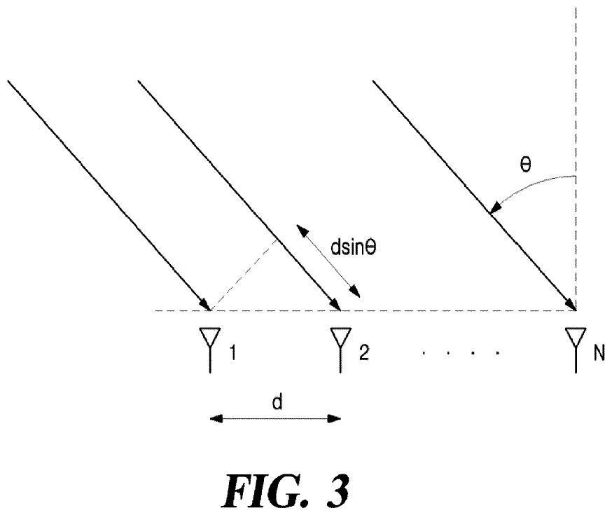

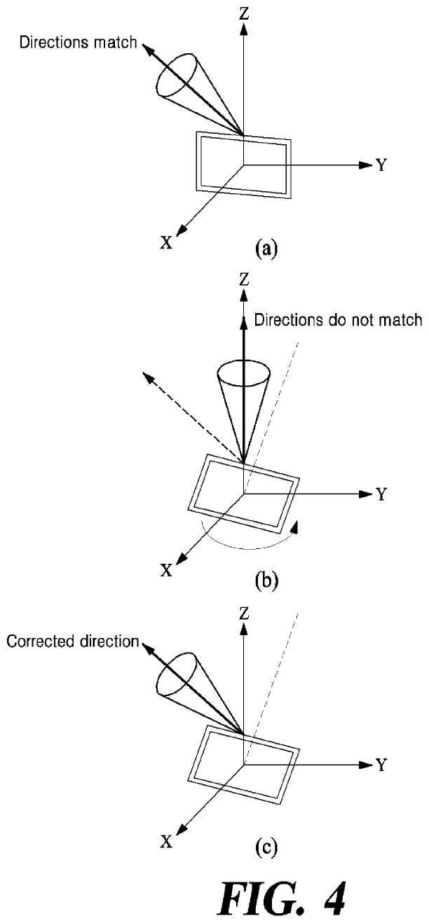

FIG. 2 is a flowchart for explaining an example of an operation of a vehicle communication apparatus. FIG. 3 is a diagram illustrating an example of a method for determining a beam direction by a vehicle communication apparatus. FIG. 4 is a diagram illustrating an example of a method for correcting a beam direction by a vehicle communication apparatus.

The vehicle communication apparatus 10 can switch the vehicle's mode to ACC mode (S200). Specifically, the vehicle communication apparatus 10 can request a passenger to switch the vehicle's mode to ACC mode. If the passenger approves, the vehicle's mode can switch to ACC mode. Alternatively, even if there is no approval from the passenger, the vehicle communication apparatus 10 can control the power of electrical components and switch vehicle's mode to ACC mode.

The vehicle communication apparatus 10 can receive a first beam directed at a particular angle θ(0°≤θ≤180°) and perform first beamforming (S202). Referring to FIGS. 3 and 4, if the distance (d) between a plurality of Wi-Fi antennas and the phase difference (dsin θ) between incident waves are known, the angle θ can be calculated by using a DoA technique. The vehicle communication apparatus 10 can determine the direction of a communication target by using a DoA technique. When the first beam direction of a target communicating with the vehicle communication apparatus 10 changes with a tilt, rotation, and movement of the vehicle communication apparatus 10 caused by a motion of the vehicle communication apparatus 10, the amount of change in first beam direction can be measured and corrected. FIG. 4(a) shows that the beam direction of the vehicle communication apparatus 10 and the beam direction of the communication target match. FIG. 4(b) shows that their beam directions do not match due to a rotation of the vehicle communication apparatus 10. FIG. 4(c) shows that, when the beam direction of the vehicle communication apparatus 10 is rotated at 30 degrees on the z axis, the beam direction of the communication target can be turned 30 degrees on the z axis, whereby their beam directions can remain the same. Thus, communication can be performed in the same beam direction as before regardless of rotation of the beam direction. Consequently, the vehicle communication apparatus 10 and the communication target can communicate with each other without physical movement.

The vehicle communication apparatus 10 can calculate first received power Prₐ by using a first beamforming result (S204). The received power also can be calculated by using Equation 1. There may be variations in received power depending on the characteristics of the communication system,

The vehicle communication apparatus 10 can switch the vehicle's mode to IGN on or Start mode (S206). Specifically, the vehicle communication apparatus 10 can request a passenger to switch the vehicle's mode to IGN on or Start mode. If the passenger approves, the vehicle's mode is switched to IGN on or Start mode. Alternatively, even if there is no approval from the passenger, the vehicle communication apparatus 10 can control the power of electrical components and switch vehicle's mode to IGN on or Start mode.

The vehicle communication apparatus 10 can receive a second beam at the same angle θ as the first beamforming and perform second beamforming (S208). The vehicle communication apparatus 10 can measure and correct the amount of change in second beam direction by using the method of measuring and correcting the amount of change in first beam direction.

The vehicle communication apparatus 10 can calculate second received power Prₛ by using a second beamforming result (S210).

The vehicle communication apparatus 10 can compute the absolute value (X, X=|Prₐ−Prₛ|) of a difference between the first received power Prₐ and the second received power Prₛ. The vehicle communication apparatus 10 can compare X with an arbitrary set value K (S212). In some implementations, K can be changed by a passenger.

If X is deemed to be less than K, the vehicle communication apparatus 10 can determine that there is no internal noise (X<K). The vehicle communication apparatus 10 can switch vehicle's mode and perform first beamforming and second beamforming at other angles (S200).

If X is deemed to be greater than or equal to K, the vehicle communication apparatus 10 can determine that there is internal noise (X≥K) (S216). The vehicle communication apparatus 10 can avoid transmitting or receiving beams at a particular angle at which it determines internal noise occurs.

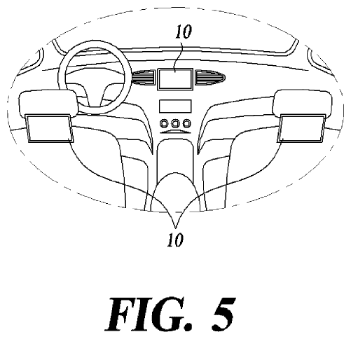

FIG. 5 is a diagram illustrating an example of a vehicle communication apparatus that is installed inside a vehicle.

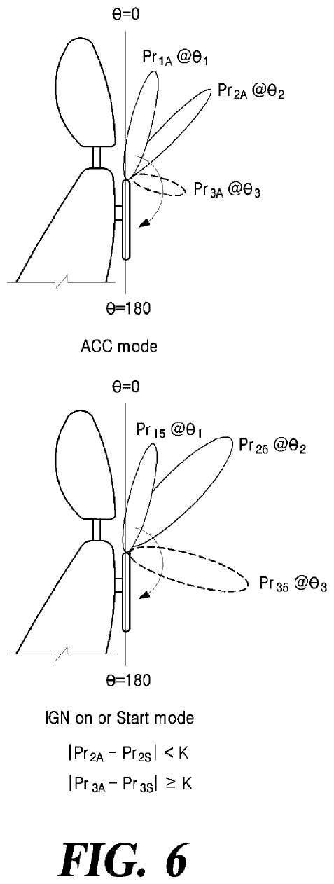

FIG. 6 is a diagram illustrating an example of a process of calculating a difference in received power by a vehicle communication apparatus.

The vehicle communication apparatus 10 can be disposed at a front seat and/or a backseat. The vehicle communication apparatus 10 can be disposed on the left and right.

The vehicle communication apparatus 10 can perform control to power on electrical components unrelated to driving and switch to ACC mode. The vehicle communication apparatus 10 can perform first beamforming at a particular angle θ₁ and calculate first received power. The vehicle communication apparatus 10 can perform control to power on all electrical components and switch to IGN on or Start mode. In some implementations, the vehicle communication apparatus 10 can perform second beamforming with respect to a beam directed at the same angle as the first beamforming and calculate second received power. Since there is no difference between the first received power and the second received power, the vehicle communication apparatus 10 can determine that a beam directed at the angle θ₁ does not have noise. Accordingly, a beam directed at the angle θ₁ is not excluded from transmission and reception.

The vehicle communication apparatus 10 can perform control to power on electrical components unrelated to driving and switch to ACC mode. The vehicle communication apparatus 10 can perform first beamforming at a particular angle θ₂ and calculate first received power. The vehicle communication apparatus 10 can perform control to power on all electrical components and switch to IGN on or Start mode. The vehicle communication apparatus 10 can perform second beamforming with respect to a beam directed at the same angle as the first beamforming and calculate second received power. In some implementations, although there is a difference between the first received power and the second received power, the vehicle communication apparatus 10 can determine that a beam directed at the angle θ₂ does not have noise since the absolute value of the difference between the first received power and the second received power is less than a set value. Accordingly, a beam directed at the angle θ₂ is not excluded from transmission and reception.

The vehicle communication apparatus 10 can perform control to power on electrical components unrelated to driving and switch to ACC mode. The vehicle communication apparatus 10 can perform first beamforming at a particular angle θ₃ and calculate first received power. The vehicle communication apparatus 10 can perform control to power on all electrical components and switch to IGN on or Start mode. The vehicle communication apparatus 10 can perform second beamforming with respect to a beam directed at the same angle as the first beamforming and calculates second received power. In some implementations, since there is a difference between the first received power and the second received power and the absolute value of the difference between the first received power and the second received power is greater than or equal to a set value, the vehicle communication apparatus 10 can determine that a beam directed at the angle θ₃ has noise. Accordingly, a beam directed at the angle θ₃ can be excluded from transmission and reception, thereby improving the communication performance of the vehicle communication apparatus.

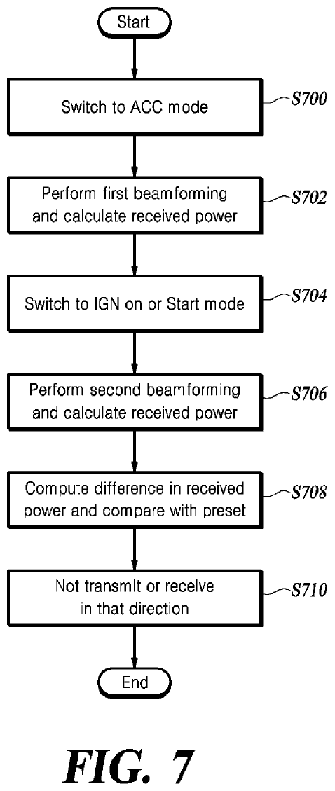

FIG. 7 is a flowchart for explaining an example of a communication method. The method shown in FIG. 7 can be implemented by being executed by a vehicle communication system including one or more physical computing devices. The following description will be given in terms of an operation performed by the vehicle communication system.

The vehicle communication system can switch vehicle's mode to ACC mode (S700). Specifically, the vehicle communication system can request a passenger to switch the vehicle's mode to ACC mode. If the passenger approves, the vehicle's mode can be switched to ACC mode. Alternatively, even if there is no approval from the passenger, the vehicle communication system can control the power of electrical components and switch the vehicle's mode to ACC mode.

The vehicle communication system can receive a first beam directed at a particular angle θ(0°≤θ≤180°) and perform first beamforming to receive first received power Pra (S702). The vehicle communication system can determine the direction of a communication target. The vehicle communication system can measure and correct the amount of change in first beam direction. There may be variations in received power depending on the characteristics of the vehicle communication system.

The vehicle communication system can switch the vehicle's mode to IGN on or Start mode (S704). Specifically, the vehicle communication system can request a passenger to switch the vehicle's mode to IGN on or Start mode. If the passenger approves, the vehicle's mode can be switched to IGN on or Start mode. Alternatively, even if there is no approval from the passenger, the vehicle communication system can control the power of electrical components and switch the vehicle's mode to IGN on or Start mode.

The vehicle communication system can receive a second beam directed at the same angle as the first beamforming and perform second beamforming to calculate second received power Prₛ (S706). The vehicle communication system can measure and correct the amount of change in second beam direction by using the method of measuring and correcting the amount of change in first beam direction.

The vehicle communication system can compute the absolute value (X, X=|Prₐ−Prₛ|) of a difference between the first received power Prₐ and the second received power Prₛ (S708). The vehicle communication system can compare X with an arbitrary set value K. In some implementations, K can be changed by a passenger.

If X is deemed to be greater than or equal to K, the vehicle communication system may determine that there is internal noise (X≥K). The vehicle communication system can operate to avoid transmitting or receiving beams directed at a particular angle at which it determines internal noise occurs.

If X is deemed to be less than K, the vehicle communication system can determine that there is no internal noise (X<K). The vehicle communication system can switch vehicle's mode and perform first beamforming and second beamforming at other angles.

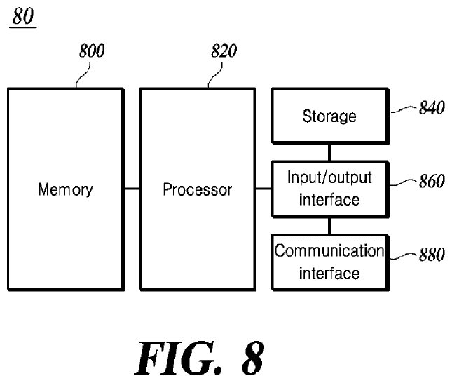

FIG. 8 is a block diagram schematically showing an exemplary computing device that can be used to implement a method and the vehicle communication apparatus 10.

The computing device 80 can include some or all of a memory 800, a processor 820, storage 840, an input/output interface 860, and a communication interface 880. The computing device 80 can structurally and/or functionally include at least some of the vehicle communication apparatus 10. The computing device 80 can be a stationary computing device such as a desktop computer, a server, an AI accelerator, etc., or can be a portable computing device such as a laptop computer, a smartphone, etc.

The memory 800 can store a program that allows the processor 820 to perform a method or operation according to various embodiments of the present disclosure. For example, the program can include a plurality of instructions executable by the processor 820, and the method shown in FIG. 7 can be performed as the plurality of instructions are executed by the processor 820.

The memory 800 can be a single memory or multiple memories. In some implementations, information needed to perform a method or operation according to various implementations of the present disclosure can be stored in the single memory or stored in the multiple memories in a distributed manner. If the memory 800 includes multiple memories, the multiple memories can be physically separated.

The memory 800 can include at least one of a volatile memory or a non-volatile memory. The volatile memory can include SRAM (static random access memory) or DRAM (dynamic random access memory), and the non-volatile memory can include a flash memory.

The processor 820 can include at least one core for executing at least one instruction. The processor 820 can execute the instructions stored in the memory 800. The processor 820 can be a single processor or a plurality of processors.

The storage 840 can retain stored data even if the power supplied to the computing device 80 is cut off. For example, the storage 840 can include a non-volatile memory or include a storage medium such as a magnetic tape, an optical disc, or a magnetic disc.

A program stored in the storage 840 can be loaded onto the memory 800 before executed by the processor 820. The storage 840 can store a file made using a program language, and a program created by a compiler or the like from the file may be loaded onto the memory 800. The storage 840 can store data to be processed by the processor 820 and/or data processed by the processor 820.

The input/output interface 860 can include an input device such as a keyboard, a mouse, etc., and may include an output device such as a display device, a printer, etc. The user can trigger execution of a program by the processor 820 via the input/output interface and/or check processing results from the processor 820.

The communication interface 880 can provide access to an external network. For example, the computing device 80 can communicate with other devices via the communication interface 880.

Each element of the apparatus or method can be implemented in hardware or software, or a combination of hardware and software. The functions of the respective elements may be implemented in software, and a microprocessor can be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various implementations can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

A computer-readable recording medium includes any type of recording device that stores data that can be read by a computer system. Such a computer-readable recording medium may be a non-volatile or non-transitory medium, such as a ROM, CD-ROM, magnetic tape, floppy disk, memory card, hard disk, optical magnetic disk, or storage device, and may further include a transitory medium, such as a data transmission medium. The computer-readable recording medium may also be distributed across a networked computer system, such that the computer-readable code is stored and executed in a distributed manner.

What is claimed is:

1. A vehicle communication method comprising:
switching a mode of a vehicle to a first state in which only an electrical component unrelated to active vehicle control is powered on;
performing first beamforming with respect to a beam directed at an angle greater than or equal to 0 degrees and less than or equal to 180 degrees;
calculating first received power of the first beamformed beam;
switching the mode of the vehicle to a second state in which all electrical components of the vehicle are powered on;
performing second beamforming with respect to the beam directed at the angle;
calculating second received power of the second beamformed beam;
comparing an absolute value of a difference between the first received power and the second received power with a preset value; and
determining, based on a result of the comparison, whether or not to transmit and receive the beam directed at the angle.

2. The vehicle communication method of claim 1, wherein determining whether or not to transmit and receive the beam includes:
performing, based on the absolute value being greater than or equal to the preset value, control such that the beam directed at the angle is not transmitted or received, and
performing, based on the absolute value of being less than the preset value, control such that the beam directed at the angle θ is transmitted or received.

3. The vehicle communication method of claim 1, wherein the preset value is adjustable.

4. The vehicle communication method of claim 1, wherein the first received power and the second received power are computed by the following equation:
$${P}_{r} = {P}_{t} \frac{{G}_{t} {G}_{r} {λ}^{2}}{{( 4 π d )}^{2}} .$$

5. The vehicle communication method of claim 1, wherein switching the mode of the vehicle to the first state includes:
requesting a passenger to switch to the first state or controlling power of the electrical components of the vehicle to switch to the first state.

6. The vehicle communication method of claim 1, wherein switching the mode of the vehicle to the second state includes requesting a passenger to switch to the second state or controlling power of the electrical components of the vehicle to switch to the second state.

7. A vehicle communication apparatus comprising:
at least one memory storing instructions; and
at least one processor configured to execute the instructions to perform operations comprising:
switching a mode of a vehicle to a first state in which only an electrical component unrelated to active vehicle control is powered on,
performing first beamforming with respect to a beam directed at an angle greater than or equal to 0 degrees and less than or equal to 180 degrees,
calculating first received power of the first beamformed beam,
switching the mode of the vehicle to a second state in which all electrical components of the vehicle are powered on,
performing second beamforming with respect to the beam directed at the angle,
calculating second received power of the second beamformed beam,
comparing an absolute value of a difference between the first received power and the second received power with a preset value, and
determining, based on a result of the comparison, whether or not to transmit and receive the beam directed at the angle.

8. The vehicle communication apparatus of claim 7, wherein determining whether or not to transmit and receive the beam includes:
performing, based on the absolute value being greater than or equal to the preset value, control such that the beam directed at the angle is not transmitted or received, and
performing, based on the absolute value of being less than the preset value, control such that the beam directed at the angle is transmitted or received.

9. The vehicle communication apparatus of claim 7, wherein the preset value is adjustable.

10. The vehicle communication apparatus of claim 7, wherein the first received power and the second received power are computed by the following equation:
$${P}_{r} = {P}_{t} \frac{{G}_{t} {G}_{r} {λ}^{2}}{{( 4 π d )}^{2}} .$$

11. The vehicle communication apparatus of claim 7, wherein switching the mode of the vehicle to the first state includes requesting a passenger to switch to the first state or controlling power of the electrical components of the vehicle to switch to the first state.

12. The vehicle communication apparatus of claim 7, wherein switching the mode of the vehicle to the second state includes requesting a passenger to switch to the second state or controlling power of the electrical components of the vehicle to switch to the second state.

13. A non-transitory computer-readable recording medium storing a computer program, wherein execution of the program causes one or more computers to perform operations comprising:
switching a mode of a vehicle to a first state in which only an electrical component unrelated to active vehicle control is powered on;
performing first beamforming with respect to a beam directed at an angle greater than or equal to 0 degrees and less than or equal to 180 degrees;
calculating first received power of the first beamformed beam;
switching the mode of the vehicle to a second state in which all electrical components of the vehicle are powered on;
performing second beamforming with respect to the beam directed at the angle;
calculating second received power of the second beamformed beam;
comparing an absolute value of a difference between the first received power and the second received power with a preset value; and
determining, based on a result of the comparison, whether or not to transmit and receive the beam directed at the angle.

14. The non-transitory computer-readable recording medium of claim 13, wherein determining whether or not to transmit and receive the beam includes:
performing, based on the absolute value being greater than or equal to the preset value, control such that the beam directed at the angle is not transmitted or received, and
performing, based on the absolute value of being less than the preset value, control such that the beam directed at the angle θ is transmitted or received.

15. The non-transitory computer-readable recording medium of claim 13, wherein the preset value is adjustable.

16. The non-transitory computer-readable recording medium of claim 13, wherein the first received power and the second received power are computed by the following equation:
$${P}_{r} = {P}_{t} \frac{{G}_{t} {G}_{r} {λ}^{2}}{{( 4 π d )}^{2}} .$$

17. The non-transitory computer-readable recording medium of claim 13, wherein switching the mode of the vehicle to the first state includes:
requesting a passenger to switch to the first state or controlling power of the electrical components of the vehicle to switch to the first state.

18. The non-transitory computer-readable recording medium of claim 13, wherein switching the mode of the vehicle to the second state includes requesting a passenger to switch to the second state or controlling power of the electrical components of the vehicle to switch to the second state.
